(19) United States
(12) Patent Application Publication
(10) Pub. No.: US 2011/0125733 A1
(43) Pub. Date: May 26, 2011

(54) QUICK ACCESS UTILITY

(76) Inventors: Nathan J. Fish, Seattle, WA (US); Jeremy M. Santy, Seattle, WA (US); Jeffrey Berg, Seattle, WA (US); Cedric P. Dussud, Seattle, WA (US); Joo-Young Lee, Redmond, WA (US); Derek M. Hans, Seattle, WA (US)

(21) Appl. No.: 12/625,893

(22) Filed: Nov. 25, 2009

(51) Int. Cl. G06F 3/048; G06F 17/30

(52) U.S. Cl. 707/723; 715/765; 715/812; 707/E17.017

(57) ABSTRACT

Users are enabled to perform tasks such as creating new content, searching for items, communicating with other users through a simplified access interface, at the same time defining a location for the access interface. A user may begin typing at any location on a canvas. The system ranks possible outcomes, suggesting one as the best match, where the user can override that choice upon which the resulting action is displayed at the point the input was initially placed. The user may be provided options to select among available tasks and the tasks may be performed without selecting an application.

### BACKGROUND

In today's computer systems, tasks are associated with one or more applications. Thus, a proper application has to be launched before a user desired task can be performed. For example, a word processing application needs to be started in order to create or edit a word processing document or a media playing application needs to be launched in order to play a music file. Once the relevant application is started, the application's user interface along with the content appears on the user's desktop at a location automatically determined by the system.

Although applications can be launched automatically by clicking on an existing file, creation of new content typically requires a user to find the relevant application (e.g. from a programs menu), start it, and activate a command for new content (e.g. open a new document). Thus, if a user creates multiple notes during the day, he/she has to launch the note application several times or leave it active on their desktop, which consumes processing power (memory, processor capacity, etc.).

As mentioned above, application user interfaces are typically placed on a predetermined location on the desktop by the operating system. Users can then move them around. When a user works with multiple applications and has other items (e.g. inactive icons, background process indicators, active program user interfaces, and comparable ones) on the desktop, automatic placement of new application user interfaces may degrade user experience.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to enabling computer users perform tasks such as creating new content through a simplified access interface, at the same time defining a location for the access interface. According to some embodiments, a user may begin typing at any location on a canvas. The system may determine a desired task associated with the typed input and provide a user interface to the user at the user selected location. Furthermore, tasks may be performed without launching an application.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates major elements in performing a computerized task in a conventional system;

FIG. 2 illustrates example elements for performing a computerized task in a system according to embodiments;

FIG. 3 illustrates an example desktop with a quick access canvas according to embodiments;

FIG. 4 illustrates interactions between major components of a system according to embodiments in providing a quick access utility;

FIG. 5 illustrates an example quick access canvas according to one embodiment;

FIG. 6 illustrates a quick access canvas according to another embodiment and its transformation;

FIG. 7 is a networked environment, where a system according to embodiments may be implemented;

FIG. 8 is a block diagram of an example computing operating environment, where a quick access utility according to embodiments may be provided; and

FIG. 9 illustrates a logic flow diagram for a process of providing a quick access utility according to embodiments.

### DETAILED DESCRIPTION

As briefly described above, computer users may be enabled to perform tasks such as creating new content through a simplified access interface without having to launch an application, at the same time defining a location for the access interface. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for providing various computing services such as word processing, media playing, web browsing, or similar applications. Examples of platforms include, but are not limited to, a hosted service executed over a plurality of servers, an application executed on a single server, and comparable systems. The term “server” refers to a computing device executing one or more software programs typically in a networked environment. The term “client” refers to a computing device or software application that provides a user access to data and other software applications through a network connection with other clients and/or servers. More detail on these technologies and example operations is provided below.

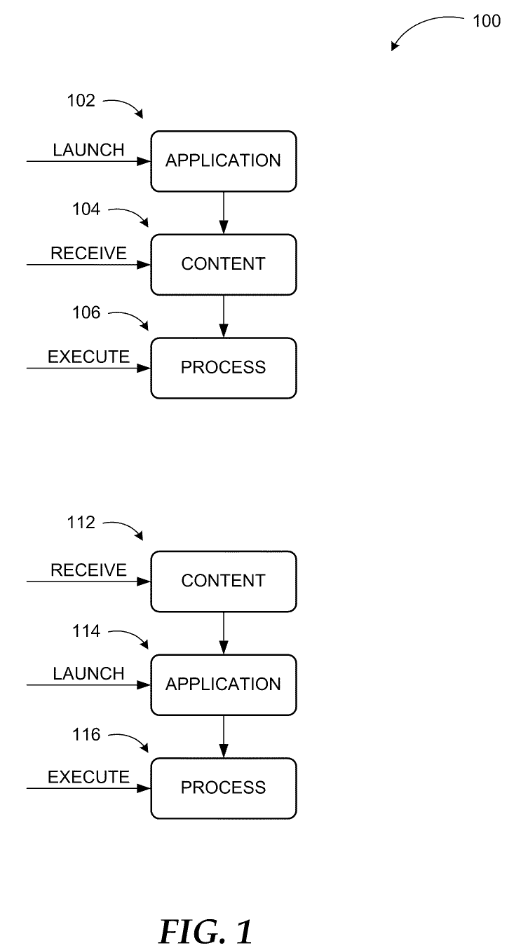

FIG. 1 illustrates major elements in performing a computerized task in a conventional system. As mentioned previously, a user typically has to launch an application before they can perform actions associated with the application in conventional systems. For example, to create a word processing document, one has to launch the word processing application first; to browse the web, a web browser has to be launched by the user; to access email, an email application has to be launched, etc. In such systems, the application and content appear on the screen in a location determined by the system and not the user.

Thus, according to some conventional systems, an application is launched (102) first. This is followed by receipt of content (104) and execution of a process (106) associated with the received content as shown in diagram 100.

Another flow includes receipt of content 112 (e.g. user selecting text or an audio recording in one application user interface, which in return activates another application user interface associated with the selected content), launching of the relevant application (114), and execution of a process (116) associated with the received content. In both cases, a particular application has to be launched consuming system resources (typically full applications and related resources) and time. Furthermore, user experience is also degraded since in some cases, the user has to find where the relevant application is in order to launch it.

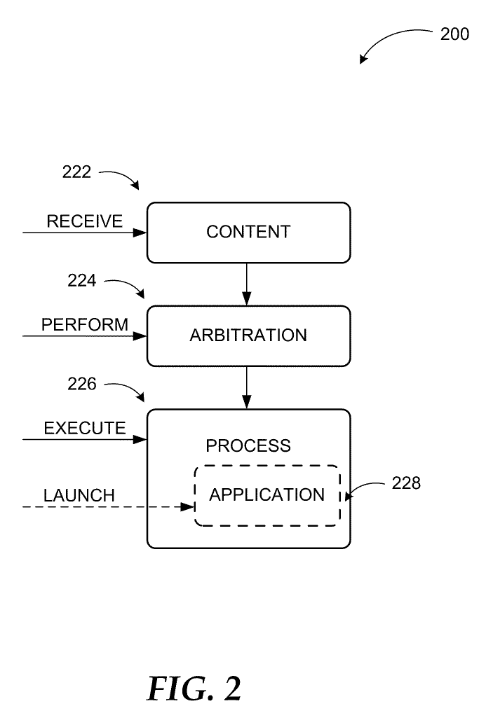

FIG. 2 illustrates in diagram 200 example elements for performing a computerized task in a system according to embodiments. A system according to embodiments enables a user to provide content (222) without the user having to select or launch a full capability application prior to providing the content or immediately following the receipt of the content. Indeed, the user does not even have to determine which application is relevant to the content. Some resources are bound to be used when tasks are performed in association with the user provided content and user intent. However, full capability applications do not need to be activated in a system according to embodiments. For example, a limited capability (and less resource consuming) image previewing application may be employed in place of a full image editing application or a thumbnail of a webpage may be presented to the user in place of a full web browser user interface.

Another aspect of a system according to embodiments is, as mentioned previously, preservation of a location on the desktop. As opposed to conventional systems, where a user interface is launched at a place on the desktop predetermined by the operating system, actions associated with the received content may be provided at the location where the user placed the content. This may be accomplished through a canvas with or without visible boundaries covering a portion of or the entire desktop. The canvas may be pannable, zoomable, or both. It may be provided as a window with defined boundaries in a portion of the desktop, as a portion of the desktop without visible boundaries, or as the entire desktop. The user is enabled to select a location on their desktop (canvas) for the activity. Following the receipt of the content (222), an arbitration process is performed (224) to determine the user's intent. The arbitration process may include an extendable voting/ranking system.

A user process associated with the received content is executed (226) based on the results of the arbitration, which may be supplemented by additional user input or selection. The process may be executed independent of an application associated with the received content or by automatically launching an application (228) associated with the content. As discussed above, a full editing application does not need to be launched to perform the task(s). If a limited capability user interface such as a calendar previewer is adequate, that may be employed in place of a full capability user interface of a calendar editing application.

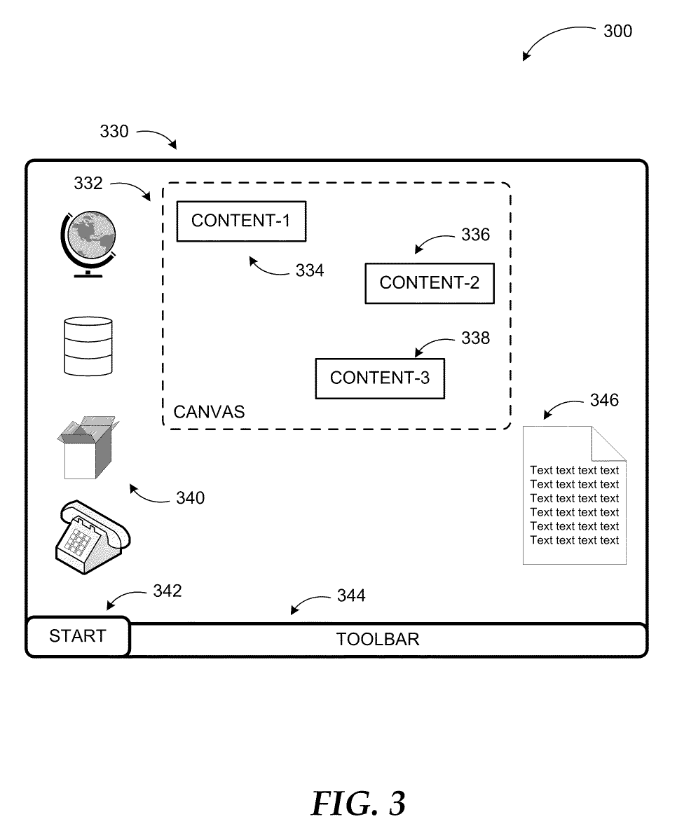

FIG. 3 illustrates an example desktop with a quick access canvas covering a portion of the desktop according to embodiments. Diagram 300 shows a computer desktop 330 with conventional elements as well as a canvas 332, which may be utilized to receive content from a user and execute desired operations based on the received content. The canvas may be pannable, zoomable, or both (a viewport opened within the canvas can be panned or zoomed to enable the user to see different parts of the canvas). The user can enter content anywhere on the canvas 332. While canvas 332 is shown in the figure as covering a portion of desktop 330, the canvas may be any size including, but not limited to, the entire desktop. Indeed, in some applications, canvas 332 may not have visible borders and cover a portion of the whole desktop depending on default parameters or user preferences.

Desktop 330 includes conventional elements such as a toolbar 344, a start menu button 342, icons 340 for launching various applications (e.g. a browser application, a communication application, a graphics applications, and comparable ones), and an open document 346. As discussed previously, a user needs to determine a relevant application (e.g. a word processing application) and launch the application from an icon on the desktop or by selecting from the start menu before being able to provide content and have the content processed.

Canvas 332 according to embodiments enables the user to provide one or more contents (e.g. 334, 336, and 338) selecting a location on the canvas to provide the content. The content may include textual data, graphical data (e.g. a drawing), a hyperlink, a file (e.g. an audio file or a shortcut to an audio file), web search results, local search results, entries to a website, and similar items.

The user may be enabled to provide the content(s) through typing, clicking, gesture(s), speech input, or comparable methods. Furthermore, content entry may be through a combination of any of these methods. For example, the user may “swipe” current windows in a particular area of the desktop 330 to another area through a gesture clearing the area of the desktop and then input content by speaking the words. Of course, other combinations may also be used.

According to one example scenario, the user may simply click and type textual content in a selected location on canvas 332. An arbitration process, as discussed above, determines based on the type of content appropriate actions. For example, if the user types in a Uniform Resource Locator (URL) address, the system may open a browser interface at the location of the typed URL address enabling the user to browse the typed website.

According to another example, the user may type or speak one or two sentences of text. The arbitration process, as described below, may determine appropriate action and rank them. The actions may then be presented to the user for selection (e.g. save into a word processing document, save as a note, email to someone, etc.). Upon receiving the user's selection, the system may perform the selected action with or without launching the relevant application.

According to a further example, the user may copy a video file onto a location on the canvas. The system (again based on the arbitration process) may present the user with the choice of viewing the video file or mailing it to someone. Upon receiving the user selection, the system may provide a full user interface or a limited user interface to perform the selected action at the location, where the video file was inserted.

User provided content(s) and their placement on the canvas may also be stored/saved across user sessions and devices according to further embodiments. Newly created items (e.g. a note) may be automatically saved to an appropriate storage location (such as a shared website or local folder) depending on where on the canvas the item is placed.

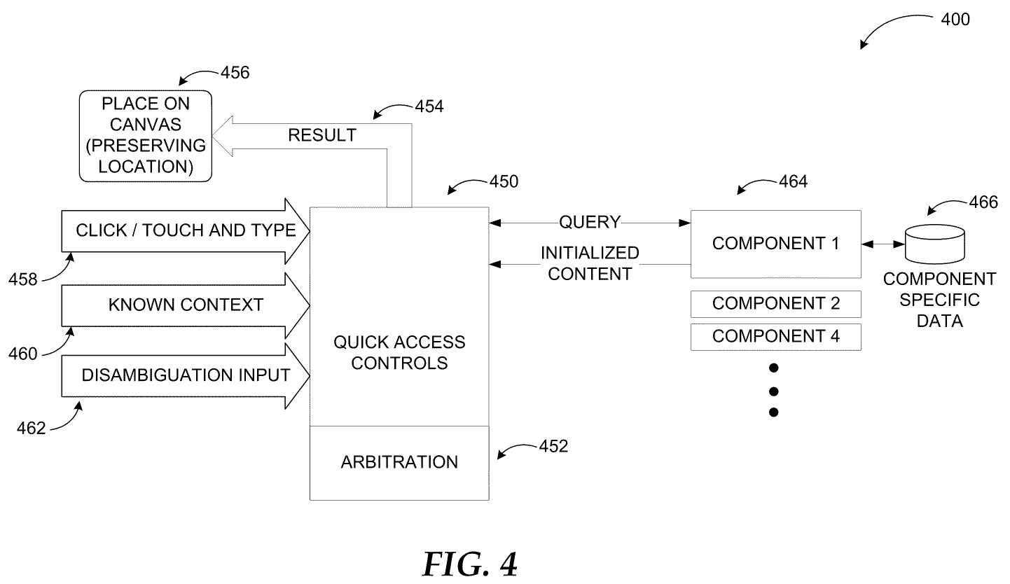

FIG. 4 illustrates diagram 400 of interactions between major components of a system according to embodiments in providing a quick access utility. A quick access utility may be implemented as an application having the canvas as its user interface, a module associated with a canvas application, or in other forms. According to some embodiments, the utility may work with an extendable voting/ranking system.

Quick access controls module 450 is responsible for receiving user input in form of click or touch and/or typing of textual entry (458). For each input action, quick access controls module 450 may ask a plurality of components if the input is a recognizable starting point for a specific type of content through a query. The components 464 may be modules providing an interface to individual applications for specific content types (e.g. word processing application, web browsing application, and comparable ones). The components 464 may also be the individual applications themselves. Each component may evaluate the input (leveraging any known user context 460 that may be provided to the quick access utility) and provide an answer if this content type is eligible. Optionally, individual components may also utilize component specific data 466, which may be stored locally or remotely. The eligible content types, provided to quick access utility as initialized content, may then be provided to the arbitration module 452 to determine likely user intent.

The arbitration module 452 may employ one or more determination algorithms such as a voting algorithm and/or a ranking algorithm. A number of factors may also be considered by the arbitration module 452 including, but not limited to, known user context 460, historical usage, location of content entry on the canvas, location of the user, time of day, user profile, and comparable ones.

According to other embodiments, quick access controls module 450 may provide the user clickable interfaces enabling them to override the arbitration process (disambiguation input 462), to select among ranked choices of action associated with eligible content types, and the like. The result(s) 454 may then be placed on the canvas (456) preserving the location of the content input by the user.

According to some example scenarios, a URL may result in a web page being presented that will navigate to the URL entered in the location specified by the user; a note may be transformed to a document with the appropriate tools; a person's name may bring up a communication interface; and so on. A system according to embodiments may be extensible such that other elements may be plugged in to participate in the process either automatically (e.g. as new applications are installed in the computing device) or by user selection. Moreover, additional contextual information may also be provided to the user by the quick access utility. For example, if the user types “Mexico.com” on the canvas, in addition to providing the option of navigating to that website, the system may list favorites or history from the user's web browser allowing the user to fine tune the results.

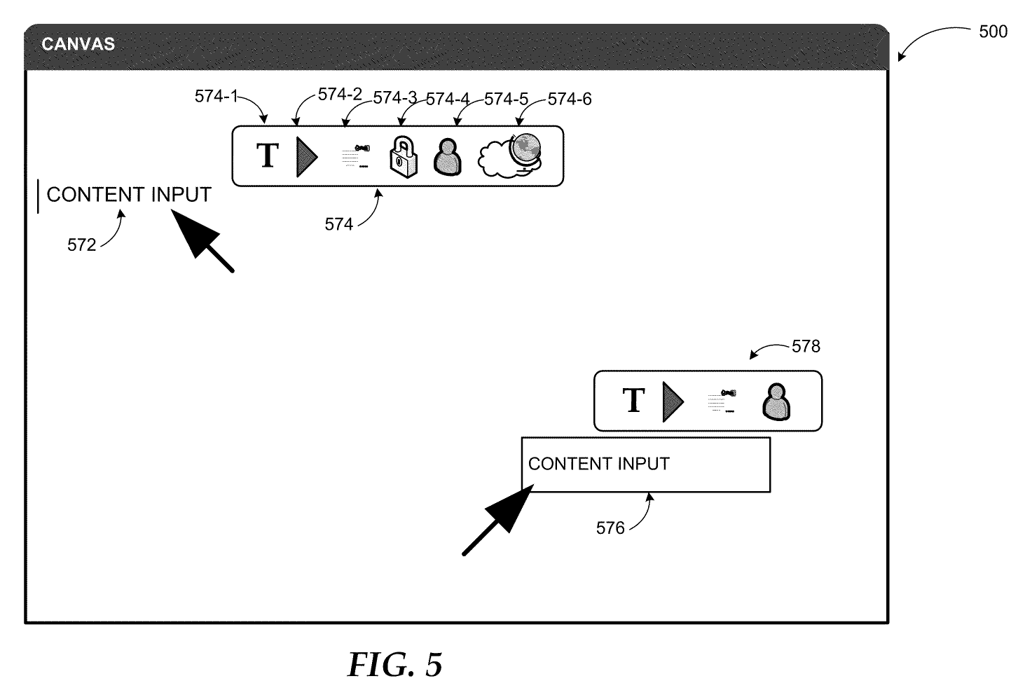

FIG. 5 illustrates example quick access canvas 500 according to one embodiment. A user of a system according to embodiments may be provided various assistance tools to provide content on the canvas. For example, the user may type (or copy) content at any location; a reference indicator such as a vertical line (or any similar indicator) may be provided to indicate a suitable location; or a text box may be provided when the system determines, the user is entering textual content. Furthermore, a canvas according to embodiments is not limited to horizontal content input. The user may be enabled to provide the content horizontally, vertically, or at any angle. The user may also be enabled to select a direction (and location) of a user interface that may be launched in response to the entered content.

As discussed previously, several choices of relevant actions may be provided to the user as a result of the arbitration process. These choices may be provided in a textual menu (e.g. a dropdown menu, a pop-up menu, and comparable ones). The choices may also be provided employing icon representations or a combination of text and icons. Moreover, the choices may be different in number and ranking depending on the content entered by the user.

In the example canvas 500, icon menu 574 is provided to the user in response to content input 572. Icon menu 574 includes representation for word processing 574-1, playback 574-2, email 574-3, security options 574-4, instant messaging 574-5, and web search 574-6. Content input 576 results in fewer offered choices in icon menu 578. Those example choices include word processing, playback, email, and instant messaging.

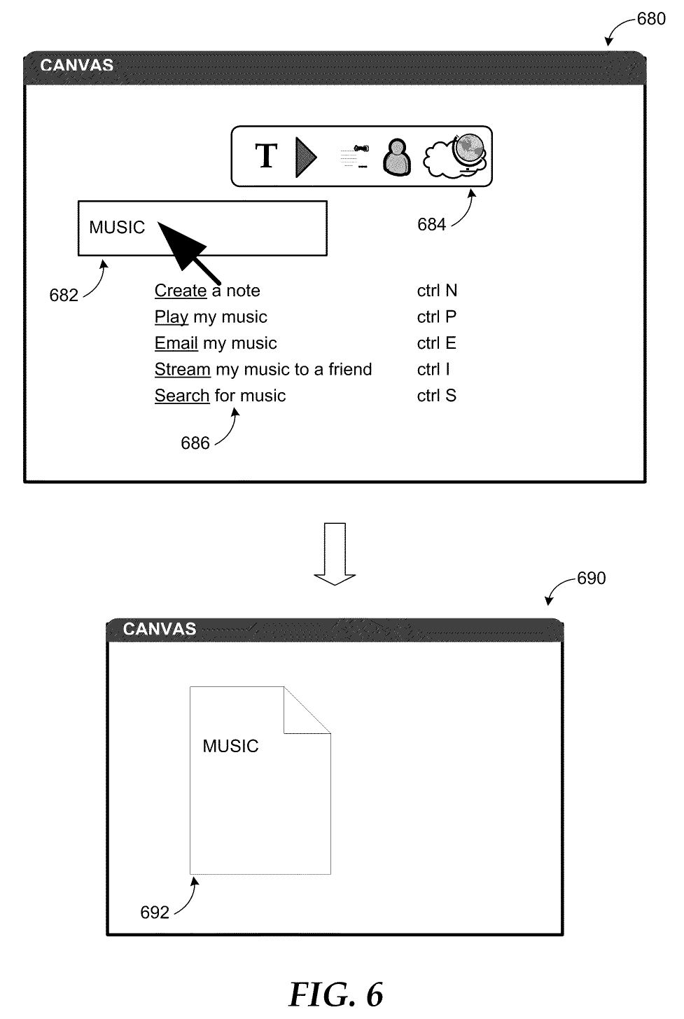

FIG. 6 illustrates a quick access canvas according to another embodiment and its transformation. On canvas 680, the user types “music” (682) at a user selected location. Following the arbitration process, five appropriate action choices are determined by the system. The choices are presented to the user in icon menu 684 as discussed above and in textual dropdown menu 686. The choices are “create a note” (the user may wish to write about music), “play my music” (the user may be provided further selection options for a particular music file to play), “email my music” (the user may wish to email a music file to a friend), “stream my music” (the user may wish to stream a music file on their computer to a friend via communication application), and “search for music” (e.g. through a web browser). For each of the textual choices, a keyboard shortcut may also be provided.

In the example scenario of FIG. 6, the user may select the first option “create a note” resulting in canvas 690, where a document 692 is opened at the location of the content entry (“music”). The document may be opened in a full user interface of a word processing application or in a simplified version of the user interface. Alternatively, the user may be enabled to continue typing and the typed content saved into a word processing document upon an indication by the user that they are finished.

While embodiments have been discussed above using specific examples of content types, user interfaces, and arbitration methods above, other approaches may be implemented using the principles described herein. Moreover, other components, elements, and graphical aspects may be employed implementing embodiments.

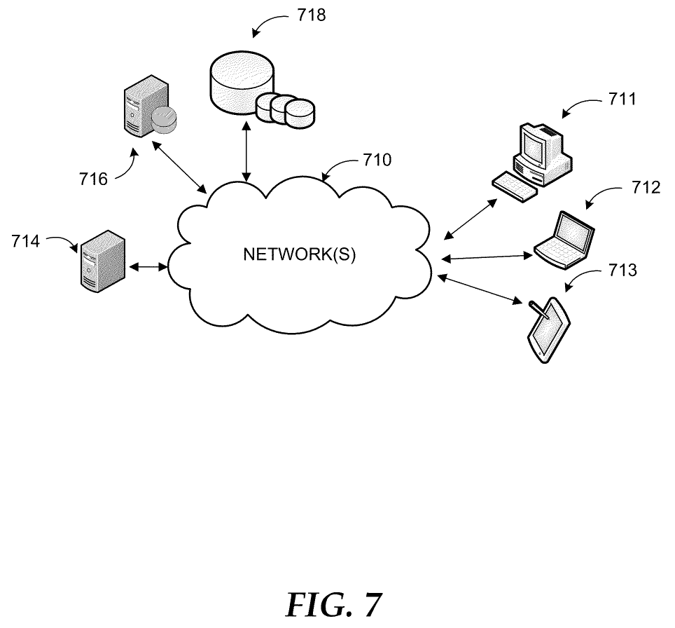

FIG. 7 is an example networked environment, where embodiments may be implemented. A platform providing quick access utility with location selection may be implemented via software executed over one or more servers (e.g. server 714) such as a hosted service. The platform may communicate with applications on individual computing devices such as a desktop computer 711, laptop computer 712, and smart phone 713 (‘client devices’) through network(s) 710.

Client devices 711-713 are capable of communicating through a variety of modes and exchange documents. A quick access utility executed in one of the client devices or one of the servers (e.g. server 714) may store and retrieve data associated with the user requested tasks to and from a number of sources such as data stores 718, which may be managed by any one of the servers or by database server 716.

Network(s) 710 may comprise any topology of servers, clients, Internet service providers, and communication media. A system according to embodiments may have a static or dynamic topology. Network(s) 710 may include a secure network such as an enterprise network, an unsecure network such as a wireless open network, or the Internet. Network(s) 710 may also comprise a plurality of distinct networks. Network(s) 710 provides communication between the nodes described herein. By way of example, and not limitation, network(s) 710 may include wireless media such as acoustic, RF, infrared and other wireless media.

Many other configurations of computing devices, applications, data sources, and data distribution systems may be employed to implement a system providing a quick access utility. Furthermore, the networked environments discussed in FIG. 7 are for illustration purposes only. Embodiments are not limited to the example applications, modules, or processes.

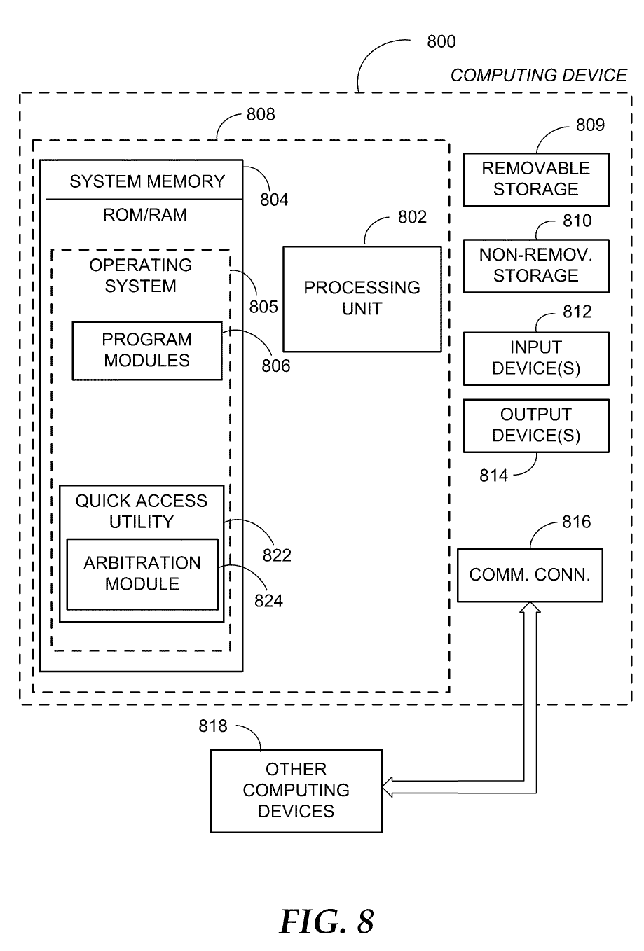

FIG. 8 and the associated discussion are intended to provide a brief, general description of a suitable computing environment in which embodiments may be implemented. With reference to FIG. 8, a block diagram of an example computing operating environment for an application according to embodiments is illustrated, such as computer 800. In a basic configuration, computer 800 may include at least one processing unit 802 and system memory 804. Computer 800 may also include a plurality of processing units that cooperate in executing programs. Depending on the exact configuration and type of computing device, the system memory 804 may be volatile (such as RAM), non-volatile (such as ROM, flash memory, etc.) or some combination of the two. System memory 804 typically includes an operating system 805 suitable for controlling the operation of the platform, such as the WINDOWS® operating systems from MICROSOFT CORPORATION of Redmond, Wash. The system memory 804 may also include one or more software applications such as program modules 806, quick access utility 822, and arbitration module 824.

Quick access utility 822 may be an application or an integral part of a hosted service. Quick access utility 822 receives user input such as new content, determines a relevant task and enables the user to perform actions associated with the task at a location designated by the user. Arbitration module 824 may be a separate application or an integral module of quick access utility 822. Arbitration module 824 may, among other things, determine a relevant task based on user input by implementing one or more algorithms such as a voting or ranking algorithm as discussed in more detail above. This basic configuration is illustrated in FIG. 8 by those components within dashed line 808.

Computer 800 may have additional features or functionality. For example, the computer 800 may also include additional data storage devices (removable and/or non-removable) such as, for example, magnetic disks, optical disks, or tape. Such additional storage is illustrated in FIG. 8 by removable storage 809 and non-removable storage 810. Computer readable storage media may include volatile and nonvolatile, removable and non-removable media implemented in any method or technology for storage of information, such as computer readable instructions, data structures, program modules, or other data. System memory 804, removable storage 809 and non-removable storage 810 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computer 800. Any such computer readable storage media may be part of computer 800. Computer 800 may also have input device(s) 812 such as keyboard, mouse, pen, voice input device, touch input device, and comparable input devices. Output device(s) 814 such as a display, speakers, printer, and other types of output devices may also be included. An interactive display may act both as an input device and output device. These devices are well known in the art and need not be discussed at length here.

Computer 800 may also contain communication connections 816 that allow the device to communicate with other devices 818, such as over a wireless network in a distributed computing environment, a satellite link, a cellular link, and comparable mechanisms. Other devices 818 may include computer device(s) that execute other applications. Communication connection(s) 816 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

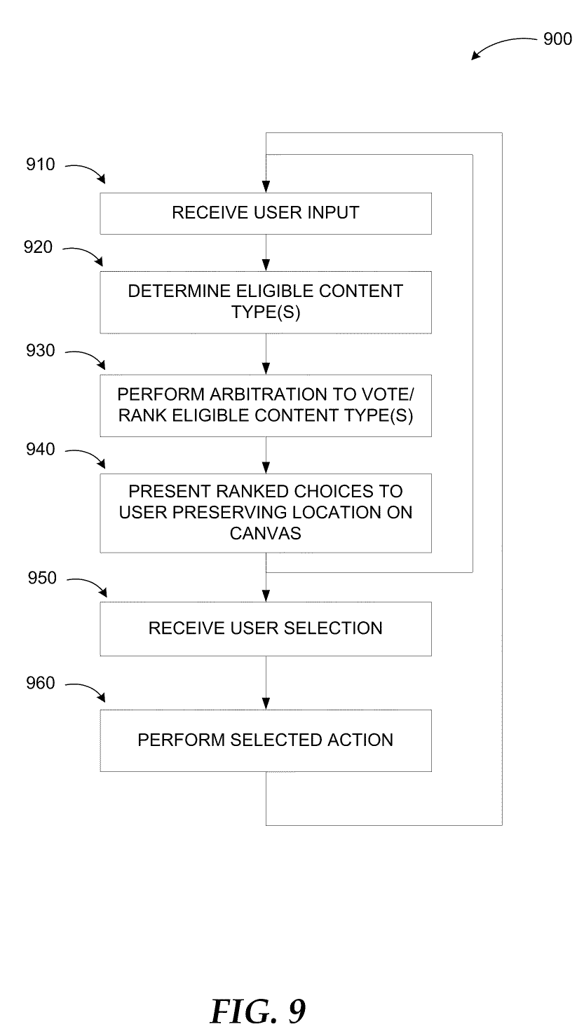

FIG. 9 illustrates a logic flow diagram for a process 900 of providing a quick access utility according to embodiments. Process 900 may be implemented by any operating system.

Process 900 begins with operation 910, where user input (content) is received on a user specified location on the canvas. The content may be textual data, graphical data, files, hyperlinks, and similar items. At operation 920, eligible content types are determined based on the received input. This may be performed by individual components associated with a quick access control module.

At operation 930, the eligible content types are processed by an arbitration module further to determine a ranking of choices available to the user based on the determination. Further input such as user feedback may be utilized at this step as well.

At operation 940, the ranked choices of actions associated with the user input are presented to the user preserving the location of the content on the canvas. An iterative process of receiving input and re-evaluating the input for a re-vote as illustrated by the connection between operations 940 and 910 may be performed for enhanced reliability. Upon receiving a user selection at operation 950, the selected action is performed at operation 960 again preserving the location on the canvas.

The operations included in process 900 are for illustration purposes. Providing a quick access utility may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for providing a quick access utility, the method comprising:
receiving a user input at a user selected location on a canvas displayed on a display device;
determining eligible content types based on the received user input at a processor coupled to the display device;
determining a likely user intent by performing an arbitration process to rank the eligible content types at the processor; and
performing an action associated with the received user input, wherein the action is based on one of the ranked content types, and wherein the performed action is displayed at the user selected location.

2. The method of claim 1, further comprising:
presenting at least one action based on the ranked eligible content types to a user;
receiving a user selection; and
performing the selected action.

3. The method of claim 1, wherein the canvas covers one of: a portion of a desktop displayed on the display device and the entire desktop displayed on the display device.

4. The method of claim 1, wherein the user input includes at least one from a set of: textual data, graphical data, a hyperlink, a file, and a shortcut to a file provide through at least one from a set of: typing, clicking, a gesture, and a voice based input.

5. The method of claim 1, further comprising:
submitting the user input to at least one component in form of a query; and
receiving eligible content type information from the at least one component.

6. The method of claim 5, wherein the content type information is received as initialized content.

7. The method of claim 5, wherein the at least one component includes one of: an application associated with a specific content type and a module interfacing with an application associated with a specific content type.

8. The method of claim 1, wherein the arbitration process includes executing at least one of a voting algorithm and a ranking algorithm.

9. The method of claim 1, wherein the arbitration process is configured to take into account at least one from a set of: a known user context, a historical usage, a location of the user input on the canvas, a location of a user providing the user input, a profile of the user, and a time of day.

10. The method of claim 1, further comprising:
enabling a user providing the user input to override the arbitration process.

11. A computing device for providing a quick access utility, the computing device comprising:
a display device;
a memory;
a processor coupled to the memory, the processor executing the quick access utility configured to:
receive content provided by a user at a user selected location on a canvas displayed on the display device;
determine eligible content types based on the received content;
perform an arbitration process to rank the eligible content types;
present a plurality of actions based on the ranked eligible content types;
receive a user selection; and
perform the selected action associated with the received content, wherein the performed action is displayed at the user selected location.

12. The computing device of claim 11, wherein the quick access utility is provided by one of: an application employing the canvas as user interface and a module associated with a canvas application.

13. The computing device of claim 11, wherein quick access utility is further configured to provide one of: a reference indicator and a text box at the user selected location on the canvas.

14. The computing device of claim 11, wherein the received content at the user selected location are preserved across user sessions and devices based on the user selected location.

15. The computing device claim 11, wherein the plurality of actions are presented employing at least one of a textual menu and a graphical menu, and wherein the user is enabled to one of modify and override the presented actions.

16. The computing device of claim 11, wherein the quick access utility is extensible enabling plug-in of additional components through one of: an automatic process and user selection.

17. A computer-readable storage medium having instructions stored thereon for providing a quick access utility, the instructions comprising:
receiving content provided by a user at a user selected location on a canvas covering one of a portion and an entire desktop displayed on the display device;
submitting the user provided content to a plurality of components in form of a query;
receiving eligible content type information from the plurality of components;
performing an arbitration process to rank the eligible content types, wherein the user is enabled to provide input associated with the arbitration process;
presenting a plurality of actions based on the ranked eligible content types;
receiving a user selection; and
performing the selected action associated with the user provided content, wherein the performed action is displayed at the user selected location.

18. The computer-readable storage medium of claim 17, wherein the plurality of components are configured to utilize component specific data to determine eligible content types.

19. The computer-readable storage medium of claim 17, wherein the selected action is performed employing a limited capability application associated with the user provided content.

20. The computer-readable storage medium of claim 17, wherein the user provided content includes at least one from a set of: textual data, graphical data, a hyperlink, a file, and a shortcut to a file, and wherein the user is enabled to select a direction for a user interface associated with the performed action.
